(19) United States
(12) Patent Application Publication
(10) Pub. No.: US 2004/0138957 A1
(43) Pub. Date: Jul. 15, 2004

(54) Method and apparatus for automated multi-party multivariate negotiation

(76) Inventors: Claudio Bartolini, Menlo Park, CA (US); Christopher William Preist, Bristol (GB); Andrew Robert Byde, Bristol (GB); Michal Morciniec, Bristol (GB); Carlos David Merida Campos, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/473,604

(22) PCT Filed: Apr. 11, 2002
(86) PCT No.: PCT/GB02/01686

(30) Foreign Application Priority Data
Apr. 11, 2001 (GB) 0109071.1
Jul. 31, 2001 (GB) 0118677.4

(51) Int. Cl. G06F 17/60

(52) U.S. Cl. 705/26

(57) ABSTRACT

A computerised method for improving security in multi-party multivariate negotiation between negotiating participants which communicate using an electronic communications network comprises the steps of: submitting proposals from the participants to the centralised negotiation processor via the electronic communications network; returning compatible proposals to each participant from the centralised negotiation processor; locally assigning a utility score to each compatible proposal based on the participant's preferences over the parameters being negotiated; and submitting the assigned utility scores for the compatible proposals to the centralised negotiation processor from each participant.

The present invention relates to a method and apparatus for automated multi-party multivariate negotiation, in particular, for automated multi-party multivariate negotiation that optimises the process of matching negotiation proposals while preserving the confidentiality of the participants' preferences.

The growth of electronic based trade and the explosion in electronic commerce (e-commerce) has spawned the development of automated trading systems in which each user delegates authority over some trade-related decisions to an automated agent implemented in software. The agents interact using an agreed protocol to further the user's interests, which is their main function. For example, in the context of a commercial transaction where a user wishes to by an airline ticket, the user may employ an agent which interacts with other agents employed by travel agents using a negotiation protocol to obtain the cheapest ticket fare for the customer's selected destination.

Improvements in communication systems and the accompanying increase in bandwidth has enabled transactions to take place far more frequently, quickly and cheaply than before. Market conditions are constantly changing making it difficult for human users to react fast enough to negotiate in response to the fluctuating market conditions. These factors have contributed to the increase in the use of automated transaction/negotiation systems.

However, a major concern for participants using such automated trade negotiation systems, such as auctions, is the problem of fraud, especially that committed, for example, by dishonest arbitrators or auctioneers who collude with other participants by making use of bid information accessible to them from the arbiter or auctioneer servers (central servers) where admissions procedures take place and where information relating to the bids or negotiations is processed or stored.

The disadvantages of known automated negotiation systems which incorporate security features, is that they have been developed from the arbiter or auctioneer's point of view, and take for granted that the role of the central server employed for checking the compatibility of negotiation proposals can be trusted by all parties.

A case of particular interest is that of a multi-party multivariate process which can be described as an exchange of negotiation proposals over a number of parameters among the participants to the negotiation itself. A negotiation proposal consists of an assignment of values to a pre-agreed set of variable attributes of the object of negotiation. Values assigned to the attributes can either be point values (e.g. price=200, color=green) or constraints expressing a range of possible values (e.g. price<350, color=red OR blue).

Every time a new proposal is submitted, it has to be checked against pre-existing valid proposals for compatibility. Two negotiation proposals are compatible if they present compatible assignments or constraints over the variable attributes of the object of negotiation.

Consider now a multi-party negotiation process over multiple parameter, in which compatibility among proposals is a necessary condition to agreement formation. But, this is not sufficient as more than one competing proposal might be compatible with the same proposal. For example, given the proposal:

proposal type=buy, item=shoes, price<350, color=red OR blue, both of the following competing proposals are compatible with it:

proposal type=sell, item=shoes, price=330, color=red and

proposal type=sell, item=shoes, price=320, color=blue.

In cases like this, the market mechanism has to specify the rules for deciding which among the competing proposals will be matching with the compatible one for an agreement to be formed.

It has to be noted that, when a participant to the negotiation process submits a negotiation proposal containing constraints over a range of possible values, in the general case not all the values will have the same utility to the participant. For instance a participant might be ready to accept both a proposal expressing color=red and one expressing color=blue, but having the possibility to choose, they would prefer red over blue.

International Patent Application, Publication Number WO 98/41942 (Optimark) discloses a system for matching negotiation proposals whereby not only does a participant submit an assignment of constrained values over the variable attributes, but also a measure of their preferences to a centralised computer. The measure of the participant's preferences is transmitted as part of the negotiation proposal to a central proposal compatibility checking engine.

In the example started above, the participant who is ready to accept both proposals will submit a proposal such as the following:

color=red (score 150) OR blue (score 120)

The main problem with both the above example and the system disclosed by Optimark is that the participant has to give away sensitive information about their own utility function by expressing preferences over the admissable values associated to the attributes. This requires that the role of the central engine for compatibility checking has to be trusted by all the parties, which cannot be taken for granted in general.

The invention seeks to address the above-mentioned problem.

According to a first aspect of the invention there is provided a computerised method for improving security in a multi-party multivariate negotiation between negotiating participants that communicate using an electronic communications network, said method comprising: submitting proposals from said participants to a centralised negotiation processor via said electronic communications network; returning compatible proposals to each participant from said centralised negotiation processor; locally assigning a utility score to each compatible proposal based on the participant's preferences over parameters that are the subject of the negotiation; and submitting said assigned utility scores for the compatible proposals to said centralised negotiation processor from each participant.

According to a second aspect of the invention there is provided a computerised method for improving security in a multi-party multivariate negotiation between negotiating participants that communicate using an electronic communications network, said method comprising: submitting proposals from said participants to a centralised negotiation processor comprising a best assignment processor, via said electronic communications network; returning compatible proposals to each participant from said centralised negotiation processor; locally assigning a utility score to each compatible proposal based on the participant's preferences over parameters that are the subject of the negotiation; submitting said assigned utility scores for the compatible proposals to said centralised negotiation processor from each participant; determining the best possible matching of compatible proposals on the basis of said utility scores assigned to said proposals using said best assignment processor; and applying a tiebreak condition to the determination of the best possible matching of compatible proposals if more than one proposal is determined by said best assignment processor to be the best possible match to a compatible proposal.

According to a third aspect of the invention there is provided a computerised method for improving security in a multi-party multivariate negotiation between negotiating participants that communicate using an electronic communications network, said method comprising: submitting proposals from said participants to a centralised. negotiation processor comprising a centralised compatibility checker and a best assignment processor, via said electronic communications network; analysing said proposals for compatibility using said centralised compatibility checker: returning compatible proposals to each participant from said centralised negotiation processor; locally assigning a utility score to each compatible proposal based on the participant's preferences over parameters that are the subject of the negotiation; submitting said assigned utility scores for the compatible proposals to said centralised negotiation processor from each participant; and determining the best possible matching of compatible proposals on the basis of said utility scores assigned to said proposals using said best assignment processor.

According to a fourth aspect of the invention there is provided a computerised method for improving security in a multi-party multivariate negotiation between negotiating participants that communicate using an electronic communications network, said method comprising: admitting participants to said negotiation process using an admissions process; initialising a negotiation infrastructure to be used; submitting proposals from said participants to a centralised negotiation processor via said electronic communications network; returning compatible proposals to each participant from said centralised negotiation processor; locally assigning a utility score to each compatible proposal based on the participant's preferences over parameters that are the subject of the negotiation; submitting said assigned utility scores for the compatible proposals to said centralised negotiation processor from each participant; and determining the best possible matching of compatible proposals on the basis of said utility scores assigned to said proposals using said centralised negotiation processor.

According to a fifth aspect there is provided apparatus for improving security in a multi-party multivariate negotiation, comprising: a plurality of participants configured to issue negotiation proposals, each participant comprising an input data port and an output data port; a centralised negotiation processor arranged to match compatible negotiation proposals; an input data port coupled to said centralised negotiation processor; and an output data port coupled to said centralised negotiation processor; said centralised negotiation processor being in communication with said participants across an electronic communications network between said respective input data ports and output data ports of the participants and itself; each participant comprising a local scoring processor for assigning a utility score to compatible negotiation proposals based on the participant's preferences relating to the parameters of the negotiation, and configured to submit these utility scores to said centralised negotiation processor; said centralised negotiation processor being configured so as to use said utility scores for matching compatible proposals.

According to a sixth aspect there is provided apparatus for improving security in a multi-party multivariate negotiation, comprising: a plurality of participants configured to issue negotiation proposals, each participant comprising an input data port and an output data port; a centralised negotiation processor comprising a centralised compatibility checker for determining compatible negotiation proposals and a best assignment processor for matching best possible compatible negotiation proposals; an input data port coupled to said centralised negotiation processor; and an output data port coupled to said centralised negotiation processor; said centralised negotiation processor being in communication with said participants across an electronic communications network between said respective input data ports and output data ports of the participants and itself; each participant comprising a local scoring processor for assigning a utility score to compatible negotiation proposals based on the participant's preferences relating to the parameters of the negotiation, and configured to submit these utility scores to said centralised negotiation processor; said centralised negotiation processor being configured so as to use said utility scores for matching compatible proposals.

According to a seventh aspect there is provided a participant client for issuing negotiation proposals in an improved security multi-party multivariate negotiation comprising a centralised negotiation processor, said client comprising: an input data port for receiving compatible negotiation proposals from said centralised negotiation processor; an output data port for submitting negotiation proposals to said centralised negotiation processor; a local scoring processor for assigning a utility score to compatible negotiation proposals based on the participant's preferences relating to the parameters of said negotiation, and configured to submit these utility scores to said centralised negotiation processor; and a local database for holding information of the participant's preferences, and which is accessible to said local scoring processor for assigning utility scores to said compatible negotiation proposals.

According to an eighth aspect there is provided a Preference Map for improving security in a multi-party multivariate negotiation between negotiating participants which communicate using an electronic communications network, the preference map containing information describing the participant's preferences according to the first or second aspect.

According to a ninth aspect there is provided a centralised negotiation engine for matching compatible negotiation proposals in an improved security multi-party multivariate negotiation comprising participants for assigning utility scores to compatible negotiation proposals, each participant having a client, said engine comprising: an input data port for receiving negotiation proposals from the participants' clients; and an output data port for returning compatible negotiations proposals to said participants; said engine being in communication with said participants across an electronic communications network between said respective input data ports and output data ports, of the participants and itself, and configured so as to use said utility scores for matching compatible proposals.

According to a tenth aspect there is provided a centralised negotiation engine for matching compatible negotiation proposals in an improved security multi-party multivariate negotiation comprising participants for assigning utility scores to compatible negotiation proposals, each participant having a client, said engine comprising: an input data port for receiving negotiation proposals from the participants' clients; a centralised compatibility checker for determining compatible negotiation proposals; a best assignment processor for matching best possible compatible negotiation proposals. an output data port for returning compatible negotiations proposals to said participants; said engine being in communication with said participants across an electronic communications network between said respective input data ports and output data ports of the participants and itself, and configured so as to use said utility scores for matching compatible proposals.

A specific embodiment of the invention will now be described, by way of example only, with reference to the accompanying drawing in which:

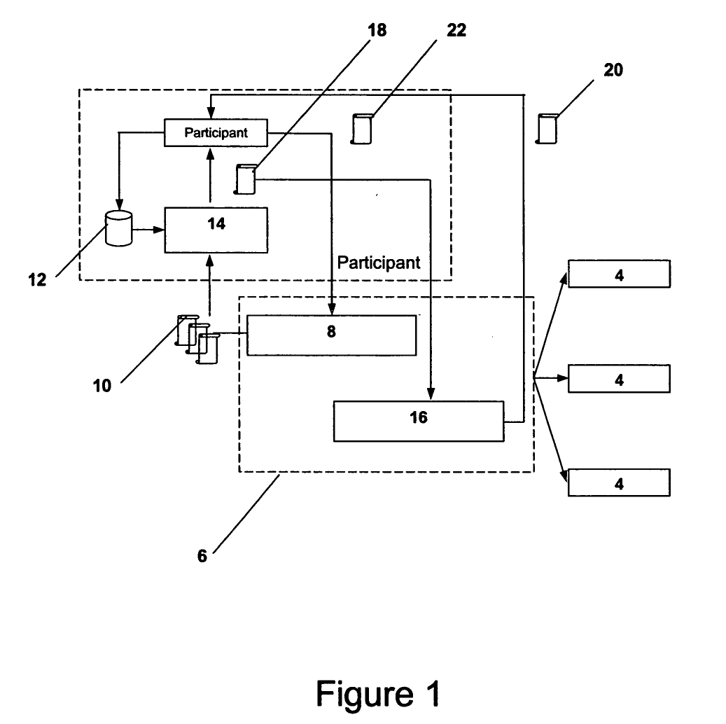

FIG. 1 shows a block diagram of an embodiment according to the invention.

A preferred embodiment provides an automated method and apparatus for embedding a market mechanism that can maximize the global utility of all the participants in a multi-party negotiation process over multiple parameters, and does not require the participants to publish their preferences and, therefore, give away important confidential information to that could be used by other participants in the negotiation process.

Accordingly, the participant keeps its preferences secret by providing a relative score of the competing compatible proposals. To illustrate this the example used above is continued. Suppose a participant has the following preferences:

Color: red—score: 90

Color blue—score: 60

Price: x—Score: (500-x)

The participant will give the proposal P1 (proposal type=sell, item=shoes, price=330, color=red) a score of 90+(500−330)=260

The participant will give the proposal P2 (proposal type=sell, item=shoes, price=320, color=blue), a score of 60+(500−320)=240

Normalizing the scores, the participant will rate the proposal P1 as 52% and the proposal P2 as 48%. This is all the information that the participant has to give away. In processes where the participant gives away its preferences, that information may be tailored by the seller/auctioneer to extract as much value from the participant as possible, by selling the red shoes up to 350, a price at which the participant will still prefer red shoes over blue ones.

Thus the invention herein described can maximize the global utility of all the participants in a multi-party negotiation process over multiple parameters, but does not require the participants to give away private information on the utility that they associate to a particular assignment of values to an attribute.

A further example will be explained to help in clarifying the proposed implementation, with reference to FIG. 1..

After going through an admission process, each of the participants 4 to negotiation will submit proposals 22 that do not contain any expressions of preferences to a central compatibility checking engine 8 forming part of a central negotiator 6. In this second example the participants are three buyers B1, B2 and B3 and two sellers S1 and S2. The sellers submit proposals PB1, PB2, PB3, PS1 and PS2.

A set of compatible proposals is computed centrally using the centralised compatibility checking engine 8 and each participant 4 is notified of all the compatible proposals 10 to the one they have submitted. In this second example, it is assumed for simplicity that all of the sellers' proposals are compatible with all the buyers' proposals. So then each of the buyers receives notification of PS1 and PS2, and each of the sellers receives notification of PB1, PB2 and PB3.

Next, the participants 4 who submitted proposals 22 assign a relative score to competing compatible proposals 10 according to preferences stored in a local preferences' database 12 using a local module that acts as a private proposal evaluator 14. Given an outstanding proposal that has been submitted by one of the participant's counterparts, the local private proposal evaluator 14 will rank it against competing proposals based on the participant's preferences and assign relative scores to the compatible proposals. In this example, the scores are assigned as in the following

TABLE A

| | PB1 | PB2 | PB3 | PS1 | PS2 |
|---|---|---|---|---|---|
| B1 | | | | 52 | 48 |
| B2 | | | | 46 | 54 |
| B3 | | | | 59 | 41 |
| S1 | 32 | 38 | 30 | | |
| S2 | 39 | 31 | 40 | | |

From hereon there are two ways in which the best possible matching of compatible proposals is carried out.

In the first way, the relative scores 18 assigned to competing compatible proposals are then sent to a best assignment computation module 16 forming part of the central negotiator 6. The computation module 16 computes the best possible matching of proposals with respect to the relative score that each participant has declared.

To compute the best assignment, the following simplified table B can be computed, where for each entry B(Si,Bj), the weighted sum of A(Si,PBj) and A(Bj,PSi) is copied. A fair distribution of weights would take into account how many competing proposals there are on each side. In this example, to give the sellers an equal discrimination power as the buyers have, the sellers preferences should be weighed as 3/2 the buyers preferences.

In general it would write be written:

B(Si,Bj)=n*A(Si,PBj)+m*(Bj,PSi)

The weights could be skewed to give more relative importance to the buyers or sellers preferences if needed. A skewing factor can be introduced with a couple of integers ks, kb, and by defining the sellers skewing factor as ks/(ks+kb) and the buyers skewing factor as kb/(ks+kb). The formula becomes:

B(Si,Bj)=[ks/(ks+kb)]*n*A(Si,PBj)=[kb/(ks+kb)]*m*A(bj,PSi)

In this example, assuming ks=kb=1 (i.e. fair treatment of preferences of sellers and buyer), for the entry (B(S1,B1):

B(S1,B1)=3*A(S1,PB1)+2*A(B1,PS1)=3*32+2*52=96+104=200

Completing the table B, it would look as follows:

| | B1 | B2 | B3 |
|---|---|---|---|
| S1 | 200 | 206 | 208 |
| S2 | 183 | 201 | 202 |

The problem to solve now, is to find an assignment of each of the sellers to one buyer under the constraint that a buyer can be assigned to at most one seller, while maximizing the global utility. In the dual case, where the buyers outnumber the sellers, we would assign each buyer to one seller. The problem is equivalent to the maximised version of the Generalized Assignment Problem (GAP), from operations research, and can be formulated as follows:

Let there be m selling proposals submitted by the sellers S1 . . . Sm

Let there be n buying proposals submitted by the buyers B1 . . . Bn

Assume m<=n (or switch sellers with buyers if that is not true)

Let xij=1 when Si is assigned to Bj, in a possible solution of the generalized assignment problem; 0 otherwise

Let uij=the entry (Si,Bj) in the table we just computed. That is given by the relative score that Bj assigns to the proposal PSi plus the relative score that Si assigns to the proposal PBj.

The problem is now:

max S(i=1 . . . m; S(j==1 . . . n; xij*uji)

s.t. for each j=1 . . . n, S(i=1 . . . m; xij)<=1 (each j is assigned to exactly one i)

for each i=1 . . . m, S(j−=1 . . . n; xij)=1 (each i is assigned to exactly one j)

where S(i=1 . . . m(i) means the sum for I equals 1 to m of the quantities f(i)

The best assignment of selling proposals to buying proposals can be computed by applying well known algorithms for the solution of the generalized assignment problem.

In this example, the best assignment is then S1-B3 and S2-B2, for a global utility of 208+201=409.

Notice that B1's request will remain unsatisfied, and both S1 and S2 will not be assigned to their first choice.

In the second way aggregate scores are computer for each proposal from Table A, as follows:

| | B1 | B2 | B3 |
|---|---|---|---|
| S1 | 84 | 84 | 89 |
| S2 | 77 | 85 | 81 |

The problem to solve now, is to find an assignment of each of the sellers to each of the buyers, under the constraint that a buyer can be assigned to at most one seller and vice versa, while maximizing the global utility.

The problem is equivalent to the maximised version of the Assignment Problem (AP), from operations research, and can be formulated as follows:

Let there be n selling proposals submitted by the sellers S1 . . . Sn and n buying proposals submitted by the buyers B1 . . . Bn

Let xij=1 when Si is assigned to Bj, in a possible solution of the assignment problem;;0 otherwise

Let uij=the entry (Si, Bj) in the table above just computed. This is given by the relative score that Bj assigns to the proposal PSi plus the relative score that Si assigns to the proposal PBj.

The problem is now:

max S(l=1 . . . m; S(j=1 . . . n; xij*uij)

s.t. for each j=1 . . . n, S(l=1 . . . m;xij)=1 (each j is assigned to exactly one i)

for each i=1 . . . m, S(j−=1 . . . n; xij)=1 (each i is assigned to exactly one j)

where S(l=1 . . . m f(i)) means the sum for i equals 1 to m of the quantities f(i)

The best assignment of selling proposals to buying proposals can be computed by applying well known algorithms for the solution of the assignment problem.

In this example, the best assignment is then S1-B3 and S2-B2, for a global utility of 89=85=174.

Notice that B1's request will remain unsatisfied, and both S1 and S2 will not be assigned to their first choice.

Once the best possible assignment of compatible proposals is completed, the best assignment computation module will notify the participants of the formed agreement 20.

Both of the different techniques described above return the same assignment in the example presented. Though with the computation presented in the first alternative some weak proposals might be rewarded as it would be in the case that—everything else remaining the same—the rating of B1 of the seller proposals would be:

| | PB1 | PB2 | PB3 | PS1 | PS2 |
|---|---|---|---|---|---|
| B1 | | | | <57 | <43 |

This would increase the global utility of the assignment B1-S1. This means that the best strategy for the more populated group of traders (either buyers or sellers) would be to score one of the competing proposals very high, in the hope to maximize the global utility for that assignment. With the computation presented in the second alternative, each buyer (seller) is encouraged to be sincere in rating proposals instead.

Using the methods described above it is possible to separate objective proposal compatibility checking from subjective proposal fitness measuring based on preferences without giving the user preferences away, but by only computing a relative score for it.

The participants' preferences may also be stored in the form of a preference map on the local database for access in subsequent negotiations.

Although the invention has been shown and described with respect to a best mode embodiment thereof, it should be understood by those skilled in the art that the foregoing and various other changes, omissions and additions in the form and detail thereof may be made therein without departing from the scope of the invention as claimed.

1. A computerised method for improving security in a multi-party multivariate negotiation between negotiating participants that communicate using an electronic communications network, said method comprising:
submitting proposals from said participants to a centralised negotiation processor via said electronic communications network;
returning compatible proposals to each participant from said centralised negotiation processor;
locally assigning a utility score to each compatible proposal based on the participant's preferences over parameters that are the subject of the negotiation; and
submitting said assigned utility scores for the compatible proposals to said centralised negotiation processor from each participant.

2. A method according to claim 1, further comprising:
determining the best possible matching of compatible proposals on the basis of said utility scores assigned to said proposals using said centralised negotiation processor.

3. A method according to claim 2, further comprising:
forming agreements on the basis of said matched proposals using said centralised negotiation processor.

4. A method according to claim 1, wherein locally assigning a utility score to each compatible proposal comprises accessing data relating to the participant's preferences stored on a local database.

5. A method according to claim 1, wherein said centralised negotiation processor comprises a centralised compatibility checker, and said method further comprises:
analysing the proposals for compatibility using the centralised compatibility checker, prior to returning compatible proposals to each participant from said centralised negotiation processor.

6. A method according to claim 2, wherein said centralised negotiation processor comprises a best assignment processor, and determining the best possible matching of compatible proposals is carried out using said best assignment processor.

7. A method according to claim 6, wherein determining the best possible matching of compatible proposals comprises:
applying a weighting factor to said utility scores on the basis of the ratio of competing proposals received by said best assignment processor from buyer participants and seller participants; and
running an algorithm on said best assignment processor to determine the best possible matching of compatible proposals.

8. A method according to claim 6, wherein determining the best possible matching of compatible proposals comprises:
computing an aggregate score of the utility scores assigned to each proposal by a seller participant and a buyer participant; and
running an algorithm on the best assignment processor to determine the best possible matching of compatible proposals.

9. A method according to claim 3, further comprising:
notifying the participants of the formed agreements.

10. A method according to claim 1, further comprising:
admitting participants to said negotiation process using an admissions process; and
initialising a negotiation infrastructure to be used, prior to submitting proposals from said participants to said centralised negotiation processor.

11. A method according to claim 6, further comprising:
applying a tiebreak condition to the determination of the best possible matching of compatible proposals if more than one proposal is determined by said best assignment processor to be the best possible match to a compatible proposal.

12. A computerised method for improving security in a multi-party multivariate negotiation between negotiating participants that communicate using an electronic communications network, said method comprising:
submitting proposals from said participants to a centralised negotiation processor comprising a best assignment processor, via said electronic communications network;
returning compatible proposals to each participant from said centralised negotiation processor;
locally assigning a utility score to each compatible proposal based on the participant's preferences over parameters that are the subject of the negotiation;
submitting said assigned utility scores for the compatible proposals to said centralised negotiation processor from each participant;
determining the best possible matching of compatible proposals on the basis of said utility scores assigned to said proposals using said best assignment processor; and
applying a tiebreak condition to the determination of the best possible matching of compatible proposals if more than one proposal is determined by said best assignment processor to be the best possible match to a compatible proposal.

13. A computerised method for improving security in a multi-party multivariate negotiation between negotiating participants that communicate using an electronic communications network, said method comprising:
submitting proposals from said participants to a centralised negotiation processor comprising a centralised compatibility checker and a best assignment processor, via said electronic communications network;
analysing said proposals for compatibility using said centralised compatibility checker:
returning compatible proposals to each participant from said centralised negotiation processor;
locally assigning a utility score to each compatible proposal based on the participant's preferences over parameters that are the subject of the negotiation;
submitting said assigned utility scores for the compatible proposals to said centralised negotiation processor from each participant; and
determining the best possible matching of compatible proposals on the basis of said utility scores assigned to said proposals using said best assignment processor.

14. A computerised method for improving security in a multi-party multivariate negotiation between negotiating participants that communicate using an electronic communications network, said method comprising:
admitting participants to said negotiation process using an admissions process;
initialising a negotiation infrastructure to be used;
submitting proposals from said participants to a centralised negotiation processor via said electronic communications network;
returning compatible proposals to each participant from said centralised negotiation processor;
locally assigning a utility score to each compatible proposal based on the participant's preferences over parameters that are the subject of the negotiation;
submitting said assigned utility scores for the compatible proposals to said centralised negotiation processor from each participant; and
determining the best possible matching of compatible proposals on the basis of said utility scores assigned to said proposals using said centralised negotiation processor.

15. Apparatus for improving security in a multi-party multivariate negotiation, comprising:
a plurality of participants configured to issue negotiation proposals, each participant comprising an input data port and an output data port;
a centralised negotiation processor arranged to match compatible negotiation proposals;
an input data port coupled to said centralised negotiation processor; and
an output data port coupled to said centralised negotiation processor;
said centralised negotiation processor being in communication with said participants across an electronic communications network between said respective input data ports and output data ports of the participants and itself;
each participant comprising a local scoring processor for assigning a utility score to compatible negotiation proposals based on the participant's preferences relating to the parameters of the negotiation, and configured to submit these utility scores to said centralised negotiation processor;
said centralised negotiation processor being configured so as to use said utility scores for matching compatible proposals.

16. An apparatus according to claim 15, wherein each participant further comprises a local database holding information of the participant's preferences, and which is accessible to the local scoring processor for assigning utility scores to the compatible negotiation proposals.

17. An apparatus according to claim 16, wherein information relating to the participant's preferences is stored as data in said local database.

18. An apparatus according to claim 15, wherein said centralised negotiation processor comprises a centralised compatibility checker for determining compatible negotiation proposals.

19. An apparatus according to claim 15, wherein said centralised negotiation processor comprises a best assignment processor for matching best possible compatible negotiation proposals.

20. Apparatus for improving security in a multi-party multivariate negotiation, comprising:
a plurality of participants configured to issue negotiation proposals, each participant comprising an input data port and an output data port;
a centralised negotiation processor comprising a centralised compatibility checker for determining compatible negotiation proposals and a best assignment processor for matching best possible compatible negotiation proposals;
an input data port coupled to said centralised negotiation processor; and
an output data port coupled to said centralised negotiation processor;
said centralised negotiation processor being in communication with said participants across an electronic communications network between said respective input data ports and output data ports of the participants and itself;
each participant comprising a local scoring processor for assigning a utility score to compatible negotiation proposals based on the participant's preferences relating to the parameters of the negotiation, and configured to submit these utility scores to said centralised negotiation processor;
said centralised negotiation processor being configured so as to use said utility scores for matching compatible proposals.

21. An apparatus according to claim 20, wherein each participant further comprises a local database holding information of the participant's preferences, and which is accessible to the local scoring processor for assigning utility scores to the compatible negotiation proposals.

22. An apparatus according to claim 21, wherein information relating to the participant's preferences is stored as data in said local database.

23. A participant client for issuing negotiation proposals in an improved security multi-party multivariate negotiation comprising a centralised negotiation processor, said client comprising:
an input data port for receiving compatible negotiation proposals from said centralised negotiation processor;
an output data port for submitting negotiation proposals to said centralised negotiation processor,
a local scoring processor for assigning a utility score to compatible negotiation proposals based on the participant's preferences relating to the parameters of said negotiation, and configured to submit these utility scores to said centralised negotiation processor; and
a local database for holding information of the participant's preferences, and which is accessible to said local scoring processor for assigning utility scores to said compatible negotiation proposals.

24. A participant client according to claim 23 wherein information relating to the participant's preferences is stored as data in said local database

25. A Preference Map for improving security in a multi-party multivariate negotiation between negotiating participants which communicate using an electronic communications network, the preference map containing information describing the participant's preferences as described in claim 4.

26. A Preference Map for improving security in a multi-party multivariate negotiation between negotiating participants which communicate using an electronic communications network, the preference map containing information describing the participant's preferences as described in claim 17.

27. A centralised negotiation engine for matching compatible negotiation proposals in an improved security multi-party multivariate negotiation comprising participants for assigning utility scores to compatible negotiation proposals, each participant having a client, said engine comprising:
an input data port for receiving negotiation proposals from the participants' clients; and
an output data port for returning compatible negotiations proposals to said participants;
said engine being in communication with said participants across an electronic communications network between said respective input data ports and output data ports of the participants and itself, and configured so as to use said utility scores for matching compatible proposals.

28. A centralised negotiation engine according to claim 27, comprising a centralised compatibility checker for determining compatible negotiation proposals.

29. A centralised negotiation engine according to claim 27, comprising a best assignment processor for matching best possible compatible negotiation proposals.

30. A centralised negotiation engine for matching compatible negotiation proposals in an improved security multi-party multivariate negotiation comprising participants for assigning utility scores to compatible negotiation proposals, each participant having a client, said engine comprising:
an input data port for receiving negotiation proposals from the participants' clients;
a centralised compatibility checker for determining compatible negotiation proposals;
a best assignment processor for matching best possible compatible negotiation proposals.
an output data port for returning compatible negotiations proposals to said participants;
said engine being in communication with said participants across an electronic communications network between said respective input data ports and output data ports of the participants and itself, and configured so as to use said utility scores for matching compatible proposals.
